(19) United States
(12) Patent Application Publication
(10) Pub. No.: US 2008/0110923 A1
(43) Pub. Date: May 15, 2008

(54) Syringes

(76) Inventor: Alan Julian Segal, Manchester (GB)

Correspondence Address: GREENBLUM & BERNSTEIN, P.L.C., 1950 ROLAND CLARKE PLACE, RESTON, VA, 20191, US

(21) Appl. No.: 11/795,212

(22) PCT Filed: Jan. 17, 2006
(86) PCT No.: PCT/GB06/00150

§ 371 Date: Oct. 4, 2007

(30) Foreign Application Priority Data
Jan. 18, 2005 (GB) 0500934.5

(51) Int. Cl. A61C 9/00; B67D 5/00

(52) U.S. Cl. 222/1; 433/89

(57) ABSTRACT

A syringe for dispensing a viscous settable material such as dental impression material has a tubular body (1) with an internal chamber (4), a plunger (2) movable through an open distal inlet end (5) along the chamber (4), and a nozzle (3) connected to an open proximal outlet end (6) of the chamber The outlet end (6) is wide relative to the chamber cross-section and the nozzle can be detached to facilitate cleaning after use. The nozzle (3) when detached, may be displaceable from the outlet end (6) to the inlet end (5) to remove residual material due to a close scraping action between a rim (13a) on the nozzle (3) and the interior surface of the chamber (4). The nozzle may also be non-removable so that cleaning can be readily effected due to the relatively wide outlet (6) using a pull-through.

This invention relates to syringes for use in dispensing viscous settable materials.

When taking dental impressions, viscous impression material which sets to form a semi-firm gel-like solid body is applied on a support tray to a patient's teeth within the patient's mouth. After setting, the tray and set material is removed and the slight flexibility of the solid body permits ready separation from the patient's teeth.

Typically an alginate hydrocolloid gel may be used as the impression material.

Especially where the impression is being taken at the back of the patient's mouth it can be difficult to ensure that the impression material flows to all the deep folds in the mouth and into all spaces around the teeth. Application of an even layer of impression material on the support tray is usually not adequate in itself and it is common practice to apply additional material at selected positions on the tray or directly to the teeth and/or the sulcus of the mouth, prior to insertion of the tray, using a spatula.

The use of a spatula is not wholly reliable or convenient and it would be preferable to use a wide-nozzle syringe to apply additional material directly where it is required. It is known to use a conventional medical syringe for this purpose whereby the material is dispensed through the nozzle of the syringe without any attached needle. However, there is then the problem that it is difficult to clean the syringe after use. Small amounts of impression material tend to remain within the syringe and can limit effective cleaning.

An object of the present invention is to provide a syringe suitable for use in dispensing viscous material with which effective cleaning after use can be more readily assured.

According to one aspect of the present invention there is provided a syringe for use in dispensing a viscous settable material having a body, a plunger and a nozzle, the body having an elongate storage chamber for the material with an outlet at one end for dispense of said material therethrough and an inlet at an opposite end through which the plunger is movable for effecting said dispense of said material, the nozzle being arranged for connection to the outlet, wherein the outlet has a transverse dimension which is at least a major part of the corresponding transverse dimension of the storage chamber, and the nozzle is detachably connected to the outlet.

With this arrangement, the outlet is relatively wide, suited to easy dispense of viscous material, and the nozzle is detachable to facilitate access to the nozzle and the outlet for effective cleaning. The invention therefore readily provides a reusable, cleanable syringe.

The elongate storage chamber may be a tube of circular cross-section and may be of common cross-section throughout its length. The chamber may be straight i.e. it may have a straight longitudinal axis.

The chamber may be integrated within the body, or may comprise a separate structure removably mounted within the body.

The body may comprise an elongate tubular structure. In the case where the storage chamber is integrated in the body, such chamber may be defined by all or part of the length of the body which preferably has a continuous, imperforate internal surface.

The said outlet may be of like cross-section to at least the adjacent part of the chamber. Alternatively the outlet may be tapered and/or otherwise constructed to be of different cross-section. In particular the outlet may have a peripheral rim structure for detachable cooperation with the nozzle.

The nozzle may be a tubular member which may be at least generally symmetrical about its longitudinal axis and may be tapered in a direction away from the outlet i.e. away from its rearward or distal end. The nozzle may have a discharge opening at its forward or proximal tip remote from the outlet which may extend at right angles to its longitudinal axis or which may extend in an inclined plane being defined by a chamfered tip or the like. It is also possible to use a curved or otherwise shaped nozzle.

The nozzle may have a configuration for detachable cooperation with the said outlet. Such configuration may be cooperable with the aforesaid peripheral rim structure, and may comprise a screw thread, bayonet fitting, snap-fit or twist-fit or push fit or friction fit attachment or the like. This configuration may comprise a peripheral structure around the distal end part of the nozzle. Conveniently the nozzle may have axially spaced peripheral tab and rim structures which are cooperable with peripherally spaced shoulders of the said rim structure of the outlet whereby in one rotational position the shoulders are trapped between the tab and rim structures of the nozzle, and in another rotational position the tab structures are aligned with spaces between the shoulders to allow axial displacement of the nozzle relative to the syringe body.

The plunger may comprise an elongate member such as a tube or rod having at one end a sealing structure which forms a close sliding fit within the chamber. The plunger may be operable by thumb pressure at its end opposite to the said sealing structure, and a finger grip structure may be provided on the body of the syringe.

The said sealing structure may be an end cap or the like formed separately from the said rod or tube of the plunger and may be attached thereto by a push fit or interengagement of screw threads or the like. The sealing structure may comprise a closed generally dome-shaped structure.

Most preferably the inlet of the chamber is provided by a freely open rear end of the syringe body through which the plunger can be inserted and also removed to permit introduction of the viscous material into the chamber. The inlet may be of a cross-section having at least the same dimensions as the adjacent part of the storage chamber so as to impose no restriction on the insertion and removal of the plunger. Also, if desired, the periphery of the inlet may be shaped to facilitate introduction of the viscous material and thus for example the inlet may be chamfered or in a plane at an angle to the longitudinal axis of the syringe body.

In a particularly preferred embodiment, the nozzle is detachably connected to the said outlet so as to be displaceable rearwardly within and along the storage chamber towards the inlet thereof.

Preferably also the nozzle has a part thereof, particularly a rear or distal part, which has an external cross-sectional dimension closely similar to a cross-sectional internal dimension of the storage chamber. With this arrangement, rearward displacement of the nozzle can sweep or wipe or scrape the internal surface of the storage chamber.

The nozzle part may have an external cross-sectional shape which is at least substantially the same as the internal cross-sectional shape of the storage chamber so that the sweeping or wiping can be applied around the entire periphery of the chamber. Conveniently this common shape may be circular, although other shapes are also possible.

The relative sizes of the nozzle part and the chamber may be such that the part makes a sliding fit with the internal surface of the chamber. Alternatively, the part may be smaller so that a close fit without continuous contact therebetween is established.

The arrangement may be such that the nozzle can be displaced rearwardly at least substantially completely from the outlet to the inlet.

The inlet may be freely open and of a cross-section greater than that of the nozzle part so that the nozzle can be displaced rearwardly out of the chamber through the inlet.

In accordance with a second aspect of the present invention there is provided a syringe for use in dispensing viscous settable material having a body, a plunger and a nozzle, the body having an elongate storage chamber for the material with an outlet at one end for dispense of said material therethrough and an inlet at an opposite end through which the plunger is movable for effecting said dispense of said material, the nozzle being detachably connected to the outlet so as to be displaceable rearwardly along the storage chamber towards the inlet thereof.

According to a third aspect of the invention there is provided a method of dispensing a viscous settable material using the syringe of the second aspect of the invention wherein the said material is introduced into the storage chamber through the said inlet with the nozzle connected to the outlet, the plunger is inserted through the inlet and displaced along the chamber to expel said material through the nozzle, the plunger is then removed, and the nozzle is detached from the outlet and displaced rearwardly along the chamber to eject non-dispensed material out of the chamber through the inlet.

The second and third aspects of the invention may have any or all of the features of the first aspect of the invention.

The invention will now be described further by way of example only and with reference to the accompanying drawings in which:

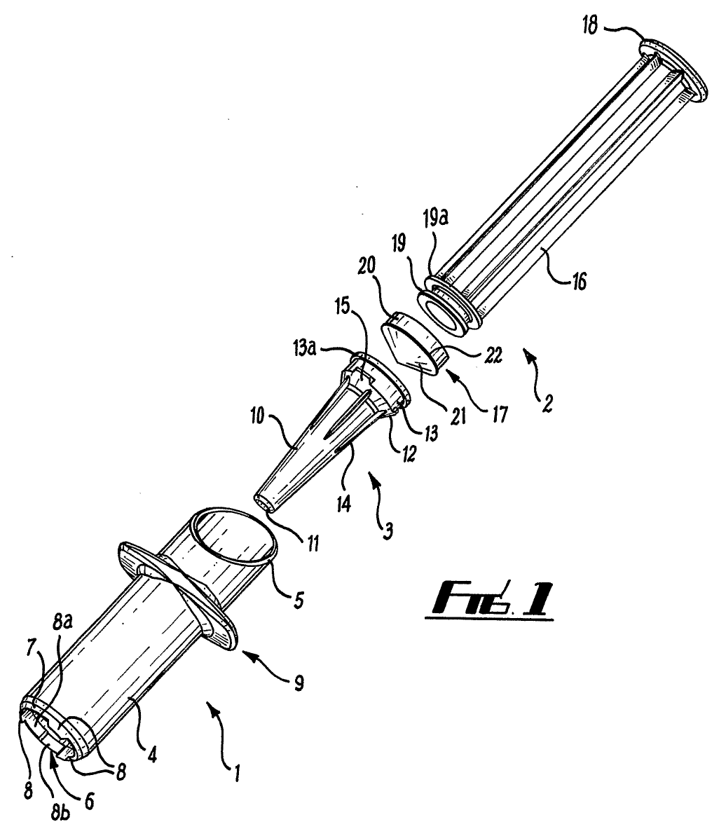

FIG. 1 is an exploded perspective view of one form of a syringe according to the invention; and

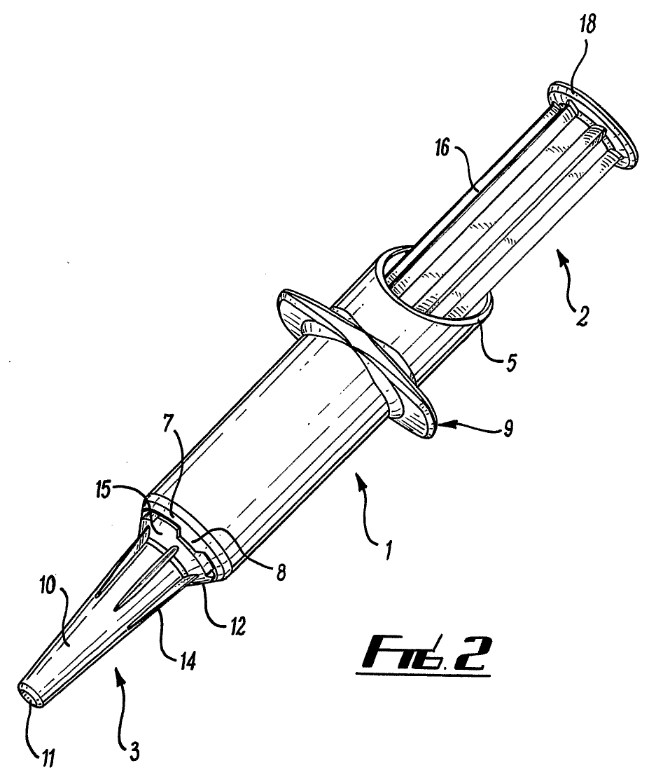

FIG. 2 is a perspective view showing the syringe assembled.

Referring to the drawings, a syringe for use in dispensing viscous material has a body 1, a plunger 2 and a nozzle 3.

The body 1 comprises a one-piece plastics structure consisting of an open-ended straight elongate tubular member 4 of substantially constant thickness and constant circular cross-section throughout its length.

At one end the member 4 is chamfered to provide an opening 5 lying in a plane at an acute angle to the longitudinal axis of the tubular member 4.

At the opposite end the member 4 has an outlet opening 6 lying in a plane at right angles to the longitudinal axis of the tubular member 4.

This opening 6 is bounded by an inwardly inclined rim 7 whereby the opening 6 is of circular cross-section but slightly smaller than the cross-section of the remainder of the tubular member 4.

This rim 7 is shaped to provide three equally spaced like tabs 8 which project axially forwardly parallel to, or slightly inclined inwardly relative to, the longitudinal axis of the member 4. Between each pair of adjacent tabs 8 there is a respective peripheral shoulder 8a and an adjacent gap 8b.

The body 1 has an integral finger grip structure 9 comprising two diametrically opposed radially outwardly projecting flanges on the outer periphery of the member 4 in its central region.

The nozzle 3 comprises a straight tubular structure which is generally symmetrical about its longitudinal axis or alternative shapes may be possible. The tubular structure is generally of circular cross-section and has a main body part 10 which is tapered to a narrow outlet opening 11 at its forward end. At the opposite end this body part 10 has a wider end which connects via an outwardly inclined peripheral neck section 12 with an end collar 13 which is generally cylindrical or slightly tapered towards the body part 10.

Gripping ribs 14 extend longitudinally at spaced positions around the periphery of the body part 10 of the nozzle and the neck section 12.

The neck section 12 has three outwardly inclined tabs 15 at equally spaced positions around its periphery which are directed rearwardly away from the narrow outlet opening 11 and which project slightly proud of the outer periphery of the end collar 13.

The inner surface of the nozzle 3 is smooth and of circular cross-section having an elongate smoothly tapered section within the 20 body part 10, a sharply tapered or inclined section within the neck section 12, and a cylindrical, or slightly tapered section within the collar 13.

As shown, the narrow outlet opening 11 which is at the forward free end of the tapered body part 10 is circular and lies in a plane perpendicular to the longitudinal axis of the nozzle 3, as also is the case with the rearward free open end of the collar 13. The diameter of the narrow outlet opening 11 is a minor proportion of the diameter of the rearward free open end of the collar 13.

This free open end is bounded around its entire periphery by a circular radially outwardly projecting rim 13a which has a radially outer smooth cylindrical peripheral surface. The external diameter of this rim 13a is slightly less than the internal diameter of the tubular member 4.

The plunger 2 has two parts: a main elongate member 16 in the form of a straight tube or rod, and an end cap 17.

The tube or rod 16 is generally of circular cross-section and has at one end an enlarged circular flat radially extending end flange 18, and at its opposite end a peripherally grooved reduced diameter cylindrical projection 19 with a radially outwardly extending circular rim 19a between the projection 19 and the main body part of the rod 16.

The end cap 17 which is made from a resilient plastics material has a tubular body part 20 of circular cross-section which snap fits or push fits at one end onto the cylindrical projection 19. At its opposite end the cap 17 is closed with a forwardly tapered surface 21 which may be domed or inclined to a leading apex. Around the periphery of the end cap 17 between the surface 21 and the body part 20 there is a circular peripheral sealing lip 22 which projects radially outwardly slightly beyond the rim 19a. The external diameter of this lip 22 is substantially the same as the internal diameter of the body 4.

In use, the end cap 17 is mounted permanently on the end of the plunger member 16 and the nozzle 3 is inserted into the tubular body 4 with the narrow outlet opening 11 first through the chamfered end 5 of the body 4. The difference in diameter between the nozzle rim 13a and the internal surface of the body 4 is small but sufficient to allow the nozzle 3 to move freely within the member 4 with the rim 13a in easy sliding contact with the member 4.

The nozzle 3 is allowed to fall down the length of the body 4 until the tapered body part 10 of the nozzle 3 projects through the rim 7 at the end of the body 4 and further outward movement of the nozzle 3 is prevented by engagement of the tabs 15 on the neck section 12 against the shoulders 8a of the rim 7. The nozzle is rotated so that the tabs 15 align with the gaps 8b and the nozzle can be pulled outwardly to cause the tabs 15 to pass through the gaps 8b as shown in FIG. 2. Further forwards movement is prevented by abutment of the rim 13a with the shoulders 8a of the rim 7. The nozzle is then rotated so that the tabs 15 abut the tabs 8 end to end and overlie the shoulders 8a outwardly of the shoulders 8a. Thereby the nozzle cannot be moved further axially either inwardly or outwardly since the shoulders 8a are trapped between the tabs 15 and the rim 13a.

If necessary, the nozzle 3 can also be pushed down the body 4 using the plunger 2.

The largest outer diameter of the nozzle 3, which is the diameter of the periphery of the rearward open end of the collar 13, is slightly less than the internal diameter of the body 4 but greater than the internal diameter of the shoulders 8a of the rim 7.

As mentioned, the largest outer diameter of the plunger 2, which is the diameter of the lip 22, is substantially equal to the internal diameter of the body 4.

The nozzle 3 can therefore move relatively easily down the body 4, and the plunger 2 can be pushed down the body 4 with a sliding, sealing fit with its internal surface.

Before insertion of the plunger 2, or after it has been inserted and drawn back the body 4 can be charged with a viscous material to be dispensed with the syringe. The interior of the body 4 thereby forms an elongate chamber for the viscous material.

The body 4 may be charged without the plunger 2 in place, with a scooping action assisted by the specially chamfered end 5, to load the viscous material into the syringe body.

The viscous material can then be discharged through the nozzle 3 by pushing the plunger 2 down the body 4.

The syringe may be used for dispensing hydrocolloid (alginate) impression material for making dental impressions. A suitable material is that sold under the Registered Trade Mark Kromopan.

The syringe described is particularly suited for use with highly viscous materials due to its relatively large diameter tubular parts.

After use, the syringe can be readily dismantled for cleaning by removing the plunger 2 and removing the nozzle 3 by pushing the nozzle 3 rearwardly out of the chamfered end 5 of the body 4, after first rotating the nozzle to align the tabs 18 with the gaps 8b. In this way residual alginate is removed from the syringe body as the nozzle is pushed out.

That is, the close proximity between the rim 13a and the inner surface of the body 4 allows the rim 13a to exert a sweeping or scraping action.

Disinfecting may then be effected in any suitable manner including autoclaving.

The separated tubular parts, particularly the body 4 and the nozzle 3, have relatively large openings thereto. Thus, the rearward free end opening of the collar 13, and the inner diameter of the rim 7 are closely similar to the inner diameter of the body 4.

This facilitates access for cleaning and ensures that residues of material do not readily become trapped.

It is of course to be understood that the invention is not intended to be restricted to the details of the above embodiment which are described by way of example only.

Thus, for example, although reference is made to applications in relation to dental impressions, the invention may be used with other materials and/or for different uses, for example for making ear impressions for use in the manufacture of hearing aids, or for body prosthetics, or for any other purpose where viscous material is required to be dispensed.

Also, whilst the nozzle is shown as being straight and symmetrical about its longitudinal axis, other arrangements may be used depending on requirements. For example the nozzle may have a curved or otherwise shaped forwards or proximal end.

Also, although reference is made to the use of a detachable nozzle, there is also the possibility of using a permanently attached nozzle, whereby cleaning is readily effected as a consequence of the width of the storage chamber outlet, and, as appropriate the freely open rear end of the syringe body, which, if desired, can permit the use of a pull-through or other cleaning aid.

Thus, and in accordance with a fourth aspect of the present invention there is provided a syringe for use in dispensing a viscous settable material having a body with a storage chamber for the material, an outlet for dispense of said material therethrough from said storage chamber, a plunger movable relative to the body for effecting said dispense of said material, and a nozzle attached to the outlet, wherein the outlet has a transverse dimension which is at least a major part of the corresponding transverse dimension of the storage chamber, and the syringe including the said body and the attached nozzle are cleanable and reusable.

Other features of the syringe of the fourth aspect of the invention may be as described above in relation to the first aspect, and the above described embodiment as appropriate.

1. A syringe for use in dispensing a viscous settable material having a body, a plunger and a nozzle, the body having an elongate storage chamber for the material with an outlet at one end for dispense of said material therethrough and an inlet at an opposite end through which the plunger is movable for effecting said dispense of said material, the nozzle being arranged for connection to the outlet, wherein the outlet has a transverse dimension which is at least a major part of the corresponding transverse dimension of the storage chamber, and the nozzle is detachably connected to the outlet.

2. A syringe according to claim 1 wherein the storage chamber is a tube of circular cross-section.

3. A syringe according to claim 1 wherein the said outlet has a peripheral rim structure for cooperation with the nozzle.

4. A syringe according to claim 3 wherein the nozzle has a peripheral structure around its distal end part for cooperation with the rim structure of the outlet.

5. A syringe according to claim 4 wherein the peripheral structure of the nozzle comprises axially spaced tabs and a rim structure between which peripherally spaced shoulders of the rim structure of the outlet can be trapped depending on the relative rotational positions of the nozzle and the chamber.

6. A syringe according to claim 1 wherein the plunger comprises an elongate member with a sealing structure at one end which forms a close sliding fit within the chamber.

7. A syringe according to claim 1 wherein the said inlet is chamfered.

8. A syringe according to claim 1 wherein the nozzle is detachably connected to the outlet so as to be displaceable rearwardly within and along the chamber.

9. A syringe according to claim 8 wherein the nozzle has a part which has an external cross-section dimension closely similar to a cross-sectional internal dimension of the chamber.

10. A syringe according to claim 9 wherein the nozzle part has an external cross-sectional shape which is at least substantially the same as the internal cross-sectional shape of the chamber.

11. A syringe according to claim 10 wherein the shape is circular.

12. A syringe according to claim 8 wherein the nozzle is displaceable substantially completely from the outlet to the inlet.

13. A syringe for use in dispensing viscous settable material having a body, a plunger and a nozzle, the body having an elongate storage chamber for the material with an outlet at one end for dispense of said material therethrough and an inlet an opposite end through which the plunger is movable for effecting said dispense of said material, the nozzle being detachably connected to the outlet so as to be displaceable rearwardly along the storage chamber towards the inlet thereof.

14. (canceled)

15. A method of dispensing a viscous settable material using the syringe of claim 13 wherein the said material is introduced into the storage chamber through the said inlet with the nozzle connected to the outlet, the plunger is inserted through the inlet and displaced along the chamber to expel said material through the nozzle, the plunger is then removed, and the nozzle is detached from the outlet and displaced rearwardly along the chamber to eject non-dispensed material out of the chamber through the inlet.

16. A syringe for use in dispensing a viscous settable material having a body with a storage chamber for the material, an outlet for dispense of said material therethrough from said storage chamber, a plunger movable relative to the body for effecting said dispense of said material, and a nozzle attached to the outlet, wherein the outlet has a transverse dimension which is at least a major part of the corresponding transverse dimension of the storage chamber, and the syringe including the said body and the attached nozzle are cleanable and reusable.
